(19) United States
(12) Patent Application Publication
(10) Pub. No.: US 2015/0019458 A1
(43) Pub. Date: Jan. 15, 2015

(54) MULTISTAGE OPTIMIZATION OF ASSET HEALTH VERSUS COSTS TO MEET OPERATION TARGETS

(71) Applicant: INTERNATIONAL BUSINESS MACHINES CORPORATION, Armonk, NY (US)

(72) Inventors: CHITRA DORAI, Yorktown Heights, NY (US); JANUSZ MARECKI, Yorktown Heights, NY (US); MAREK PETRIK, Yorktown Heights, NY (US); RUSLAN STARUSHOK, Yorktown Heights, NY (US); DHARMASHANKAR SUBRAMANIAN, Yorktown Heights, NY (US)

(21) Appl. No.: 14/326,698

(22) Filed: Jul. 9, 2014

Related U.S. Application Data
(60) Provisional application No. 61/844,713, filed on Jul. 10, 2013.

(51) Int. Cl. G06Q 40/06

(52) U.S. Cl. CPC G06Q 40/06
USPC 705/36 R

(57) ABSTRACT

A method for determining an optimal multi-stage asset management policy includes providing a plurality of decision epochs and a number of admissible asset health levels for each decision epoch, providing a portfolio of assets over the admissible asset health levels in an initial decision epoch, providing a plurality of state transition probabilities between states of an underlying asset health dynamics process for the decision epochs, where each state corresponds to a percentage of assets that has a given health level in a given decision epoch, providing an action set to which admissible actions of the state transition probabilities belong, where an action changes a state transition probability, and determining cost functions of the admissible actions on a per-asset basis, where operational targets impose constraints on probabilities that the asset health of the portfolio of assets, in one or more decision epochs, is within a specified range.

### CROSS REFERENCE TO RELATED UNITED STATES APPLICATIONS

This application claims priority from U.S. Provisional Application No. 61/844,713 of Dorai, et al., filed Jul. 10, 2013, the contents of which are herein incorporated by reference in their entirety.

### BACKGROUND

Embodiments of the present disclosure are directed to techniques for optimal, multistage (e.g. over multiple months) management of portfolio of assets, such as credit card revolving debt accounts, whose health levels (e.g. delinquency period), naturally evolves over time according to some exogenous process.

A portfolio manager is tasked with maintaining a portfolio of assets, where an asset could be a credit card revolving debt, a student loan, a mortgage, an employee skillset, an insured health etc. An asset is characterized by a health level that may change over time. For example, a health level of a student loan may correspond to the number of months that the loan is delinquent. There may be a finite number of admissible health levels of an asset. A portfolio manager can invest its resources towards improving the health levels of the assets it manages. A portfolio should meet given operation targets at different points in time. For example, only a certain percentage of total assets may be allowed to have a sub-prime health level. Thus, a portfolio manager should have a multistage investment policy for its portfolio, so that given portfolio operation targets are met with minimal investments on behalf of the portfolio manager.

The portfolio manager should then actively modulate the exogenous process for each individual asset to impact the evolution of the asset health levels to satisfy given portfolio operation targets, e.g. the percentage of portfolio loans of a given health level should be above a given threshold at a given month. These modulation efforts of the portfolio manager come at a certain cost, conditioned on asset type, modulation intensity, time etc. A useful multi-stage modulation strategy is then the one that can guarantee that the portfolio meets (in expectation) the given operation targets at a minimal extra cost to be incurred by the portfolio manager.

Constrained Markov decision processes (MDPs) with a small number of states and small finite action sets are easy to solve. Many important practical tasks, however, involve large state and action sets. While many methods have been proposed to solve regular MDPs with large state sets, there are few practical approaches for solving constrained MDPs with large action sets.

### BRIEF SUMMARY

According to an aspect of the disclosure, there is provided a method for determining an optimal multi-stage policy that minimizes asset health modulation effort costs while satisfying asset portfolio operational targets that includes providing a plurality of decision epochs and a number of admissible asset health levels, for each of the plurality of decision epochs, providing a portfolio of assets over the admissible asset health levels in an initial decision epoch, providing a plurality of state transition probabilities between states of an underlying asset health dynamics process, for the plurality of decision epochs, where each state corresponds to a percentage of the portfolio of assets that have a given asset health level in a given decision epoch, providing an action set that includes a plurality compact sets to which admissible actions of the state transition probabilities belong, where an action changes a state transition probability, and determining cost functions of the admissible actions on a per-asset basis, where operational targets impose constraints on probabilities that the asset health of the portfolio of assets, in one or more decision epochs, is within a specified range.

According to a further aspect of the disclosure, when the cost function is non-convex over a range of admissible actions, the method includes replacing the cost function by a convex hull of an envelope of the cost function.

According to a further aspect of the disclosure, replacing the cost function by a convex hull of an envelope of the cost function comprises calculating g(x)=sup{t so that (x,t) belongs to convexHull(hypoGraph(r(a, s)))}, where r(a, s) is the reward function r(s,a) of modulating, in a decision epoch, the health of an asset of health s to become, at the end of the decision epoch, an asset of health sᵢ with probability a(i), for all possible asset health levels sᵢ at the end of the decision epoch, a hypograph of a function ƒ is defined as hypoGraph (f)={(x, t): t<=f(x)}, and sup is a supremum.

According to a further aspect of the disclosure, when the costs functions are convex and the action set is finite, the method comprises determining a set of policies that optimize an expectation of the cost functions for the action set summed over all decision epochs, where a policy is a set of actions prescribed for all states, where cost functions are indexed by decision epochs and represent asset health levels in the different decision epochs, and an initial health of the asset portfolio is a probability distribution over states indexed by time 0, where the optimization is performed using a constrained Markov decision process solver and yields the optimal multi-stage policy as a solution.

According to a further aspect of the disclosure, an expected return of the optimal multi-stage policy is

$$ρ ( π ) = {\sum }_{t = 1}^{T} {{\sum }_{{s}_{t} ∈ {𝒮}_{t}}}_{{a}_{t} ∈ 𝒜 ( {s}_{t} )} r ( {s}_{t} , {a}_{t} ) \cdot {u}_{π} ( {s}_{t} , {a}_{t} )$$

where r(sₜ, aₜ) is the reward function for action aₜ being executed in state sₜ, u_{π}(sₜ, aₜ) is an probability of visiting sₜ and executing aₜ, T is the number of decision epochs, Sₜ is a set of states, A(sₜ) is the action set, subject to the constraints

$${\sum }_{{a}_{t} ∈ A ( {s}_{t} )} {U}_{π} ( {s}_{t} , {a}_{t} ) = {d}_{π} ( {s}_{t} ) , \\ {\sum }_{{s}_{t} , {a}_{t}} {u}_{π} ( {s}_{t} , {a}_{t} ) \cdot {a}_{t} ( {s}_{t + 1} ) = {d}_{π} ( {s}_{t + 1} ) , \\ {d}_{π} ( {s}_{1} ) = α ( {s}_{1} ) , \\ \frac{{u}_{π} ( {s}_{t} , {a}_{t} )}{{d}_{π} ( {s}_{t} )} = π ( {s}_{t} , {a}_{t} )$$

$${\sum }_{s ∈ {Q}_{i}} {d}_{π} ( s ) \leq {q}_{i} ,$$

where α(s_{I}) is a state probability distribution in an initial decision epoch, π(sₜ,aₜ) is a probability of applying action aₜ to state sₜ at decision epoch t, d_{π}(sₜ) is a visitation probability for state sₜ for policy π, Qᵢ is a set of visited states, and qᵢ is a visitation probability.

According to a further aspect of the disclosure, when the action set is continuous, the cost function is affine over a range of admissible modulations, and the set of actions is a polytope over the actions, the method includes replacing the continuous action set with a finite action set of extreme actions from the plurality of compact sets, using a constrained Markov decision process (MDP) solver to find a randomized policy in the finite action set of extreme actions, and converting the randomized policy into a deterministic policy that uses the admissible actions of state transition probabilities, where the deterministic policy is the optimal multi-stage policy.

According to a further aspect of the disclosure, if the constrained MDP solver returns a solution in unacceptable time, the method includes reformulating the constrained MDP as a convex optimization task, and solving the convex optimization task using a linear programming solver.

According to a further aspect of the disclosure, the convex optimization task is expressed as

max_{u≧0,d≧0}Σ_{sεS} r̅(s,u(s,))

s.t. d(s₁)=α(s₁)∀s₁εS₁,

d(sₜ)=Σₛ_{ₜ₊₁}u(sₜ,sₜ₊₁),

d(sₜ)=Σₛ_{_{t−1}}u(sₜ₋₁,sₜ),

Σ_{sεQ}_{ᵢ}d(s)≦qᵢ iεI,

ƒ̅ₛ^{j}(u(s,))≦0 jεJ,

where α(s_{I}) is a state probability distribution in an initial decision epoch, S is a set of states, d(sₜ) is a visitation probability for state sₜ,

$$\overline{r} ( s , a ) = {1}^{T} a \cdot r ( s , \frac{a}{{1}^{T} a} ) .$$

is a convex reward function where r(s, a) is the reward function for action a being executed in state s, u(s,) is a vector of values of u(sₜ, sₜ₊₁) which is a joint probability of visiting sₜ and transitioning to sₜ₊ᵢ, Q, is a set of visited states, and qᵢ is a visitation probability,

$${\overline{f}}_{s}^{j} ( a ) = {1}^{T} a \cdot {f}_{s}^{j} ( \frac{a}{{1}^{T} a} )$$

is a convex extension of constraint set

$${f}_{s}^{j} ( \frac{u ( s , )}{d ( s )} ) \leq 0$$

which constrains action set A(sₜ) to be a convex set, and where optimal solutions u*, d* define a deterministic policy π(s)=u*(s,)/d*(s) that maps a state to a vector of state transition probabilities.

According to a further aspect of the disclosure, the assets are loans, and the asset health levels are delinquency levels.

According to another aspect of the disclosure there is provided a non-transitory program storage device readable by a computer, tangibly embodying a program of instructions executed by the computer to perform the method steps for determining an optimal multi-stage policy that minimizes asset health modulation effort costs while satisfying asset portfolio operational targets. The method includes providing a plurality of decision epochs and a number of admissible asset health levels, for each of the plurality of decision epochs, providing a portfolio of assets over the admissible asset health levels in an initial decision epoch, providing a plurality of state transition probabilities between states of an underlying asset health dynamics process, for the plurality of decision epochs, where each state corresponds to a percentage of the portfolio of assets that have a given asset health level in a given decision epoch, providing an action set that includes a plurality compact sets to which admissible actions of the state transition probabilities belong, where an action changes a state transition probability, and determining cost functions of the admissible actions on a per-asset basis, where operational targets impose constraints on probabilities that the asset health of the portfolio of assets, in one or more decision epochs, is within a specified range.

According to a further aspect of the disclosure, when the cost function is non-convex over a range of admissible actions, the method includes replacing the cost function by a convex hull of an envelope of the cost function.

According to a further aspect of the disclosure, replacing the cost function by a convex hull of an envelope of the cost function comprises calculating g(x)=sup{t so that (x,t) belongs to convexHull(hypoGraph(r(a, s)))}, where r(a, s) is the reward function r(s,a) of modulating, in a decision epoch, the health of an asset of health s to become, at the end of the decision epoch, an asset of health sᵢ with probability a(i), for all possible asset health levels s, at the end of the decision epoch, a hypograph of a function ƒ is defined as hypoGraph (f)={(x, t): t<=f(x)}, and sup is a supremum.

According to a further aspect of the disclosure, when the costs functions are convex and the action space is finite, the method comprises determining a set of policies that optimize an expectation of the cost functions for the action set summed over all decision epochs, where a policy is a set of actions prescribed for all states, where cost functions are indexed by decision epochs and represent asset health levels in the different decision epochs, and an initial health of the asset portfolio is a probability distribution over states indexed by time 0, where the optimization is performed using a constrained Markov Decision Process solver and yields the optimal multi-stage policy as a solution.

According to a further aspect of the disclosure, an expected return of the optimal multi-stage policy is

$$ρ ( π ) = {\sum }_{t = 1}^{T} {\sum }_{{{s}_{t} ∈ {S}_{t}}_{{a}_{t} ∈ A ( {s}_{t} )}} r ( {s}_{t} , {a}_{t} ) \cdot {u}_{π} ( {s}_{t} , {a}_{t} )$$

where r(sₜ, aₜ) is the reward function for action aₜ being executed in state sₜ, u_{π}(sₜ, aₜ) is a probability of visiting sₜ and executing aₜ, T is the number of decision epochs, Sₜ is a set of states, A(sₜ) is the action set, subject to the constraints

$${\sum }_{{a}_{t} ∈ A ( {s}_{t} )} {u}_{π} ( {s}_{t} , {a}_{t} ) = {d}_{π} ( {s}_{t} ) , \\ {\sum }_{{s}_{t} , {a}_{t}} {u}_{π} ( {s}_{t} , {a}_{t} ) \cdot {a}_{t} ( {s}_{t + 1} ) = {d}_{π} ( {s}_{t + 1} ) , \\ {d}_{π} ( {s}_{1} ) = a ( {s}_{1} ) , \\ \frac{{u}_{π} ( {s}_{t} , {a}_{t} )}{{d}_{π} ( {s}_{t} )} = π ( {s}_{t} , {a}_{t} )$$

$${\sum }_{s ∈ {Q}_{i}} {d}_{π} ( s ) \leq {q}_{i} ,$$

where α(s_{I}) is a state probability distribution in an initial decision epoch, π(sₜ,aₜ) is a probability of applying action aₜ to state sₜ at decision epoch t, d_{π}(sₜ) is a visitation probability for state sₜ for policy π, Qᵢ is a set of visited states, and qᵢ is a visitation probability.

According to a further aspect of the disclosure, when the action set is continuous, the cost function is affine over a range of admissible modulations, and the set of actions is a polytope over the actions, the method includes replacing the continuous action set with a finite action set of extreme actions from the plurality of compact sets, using a constrained Markov decision process (MDP) solver to find a randomized policy in the finite action set of extreme actions, and converting the randomized policy into a deterministic policy that uses the admissible actions of state transition probabilities, where the deterministic policy is the optimal multi-stage policy.

According to a further aspect of the disclosure, if the constrained MDP solver returns a solution in unacceptable time, the method includes reformulating the constrained MDP as a convex optimization task, and solving the convex optimization task using a linear programming solver.

According to a further aspect of the disclosure, the convex optimization task is expressed as

max_{u≧0,d≧0}Σ_{sεS} r̅(s,u(s,))

s.t. d=(s₁)=α(s₁)∀s₁εS₁,

d(sₜ)=Σₛ_{ₜ₊₁}u(sₜ,sₜ₊₁),

d(sₜ)=Σₛ_{_{t−1}}u(sₜ₋₁,sₜ),

Σ_{sεQ}_{ᵢ}d(s)≦qᵢ iεI,

ƒ̅ₛ^{j}(u(s,))≦0 jεJ,

where α(s_{I}) is a state probability distribution in an initial decision epoch, S is a set of states, d(sₜ) is a visitation probability for state sₜ,

$$\overline{r} ( s , a ) = {1}^{T} a \cdot r ( s , \frac{a}{{1}^{T} a} ) .$$

is a convex reward function where r(s, a) is the reward function for action a being executed in state s, u(s,) is a vector of values of u(sₜ, sₜ₊₁) which is a joint probability of visiting sₜ and transitioning to sₜ₊₁, Qᵢ is a set of visited states, and qᵢ is a visitation probability,

$${\overline{f}}_{s}^{j} ( a ) = {1}^{T} a \cdot {f}_{s}^{j} ( \frac{a}{{1}^{T} a} )$$

is a convex extension of constraint set

$${f}_{s}^{j} ( \frac{u ( s , )}{d ( s )} ) \leq 0$$

which constrains action set A(sₜ) to be a convex set, and where optimal solutions u*, d* define a deterministic policy π(s)=u*(s,)/d*(s) that maps a state to a vector of state transition probabilities.

According to a further aspect of the disclosure, the assets are loans, and the asset health levels are delinquency levels.

### BRIEF DESCRIPTION OF THE SEVERAL VIEWS OF THE DRAWINGS

FIG. 1 shows an example convex function and its concave envelope over a unit square, according to an embodiment of the disclosure.

FIG. 2 depicts a convex reward function r(s, a)=a₂² and its concave envelope rₑ(s, a)=a₂, according to an embodiment of the disclosure.

FIG. 3 shows the time to solve a CMDP for as a function of number of states, according to an embodiment of the disclosure.

FIG. 4 graphs the return of the optimal solution as a function of the limit on the fraction of loans in default, according to an embodiment of the disclosure.

FIG. 5 is a flow chart of a method according to an embodiment of the disclosure.

FIG. 6 is a block diagram of an exemplary computer system for implementing a method for optimal, multistage (e.g. over multiple months) management of portfolio of assets, according to an embodiment of the disclosure.

### DETAILED DESCRIPTION

Exemplary embodiments of the disclosure as described herein generally include systems and methods for optimal, multistage (e.g. over multiple months) management of portfolio of assets. Accordingly, while embodiments of the disclosure are susceptible to various modifications and alternative forms, specific embodiments thereof are shown by way of example in the drawings and will herein be described in detail. It should be understood, however, that there is no intent to limit embodiments of the disclosure to the particular forms disclosed, but on the contrary, embodiments of the disclosure cover all modifications, equivalents, and alternatives falling within the spirit and scope of the disclosure.

Exemplary embodiments of the present disclosure include methods for solving constrained MDPs in which actions can continuously modify the transition probabilities within some acceptable sets. A method according to embodiments of the present disclosure can reduce continuous action sets to finitely large sets when the rewards are affine and feasible sets polyhedral. Another method according to embodiments of the present disclosure can replace continuous action sets by their extreme points when the rewards are linear in the modulation. Another method according to embodiments of the present disclosure is a tractable optimization problem for arbitrary concave reward functions, which can be extended to non-concave reward functions using their concave envelopes.

Embodiments of the disclosure focus on constrained MDPs in which actions can continuously modify the transition probabilities within some convex sets of acceptable probability distributions. A method according to embodiments of the present disclosure reduces the continuous action sets to finitely large ones and requires linear rewards. Embodiments of the present disclosure can replace such continuous action sets by their extreme points when the rewards are linear in the modulation. That is, statistical regression models are employed to estimate from historic data the costs and ranges of the underlying exogenous transition function modulations. Next, a model is built of the corresponding domain problem at hand, in the constrained MDP framework. The challenge of handling a continuous action space in this setting is avoided by finding randomized solutions to an identical CMDP with finite action space formed from the extreme points of original action space, with mild assumptions. While a basic, finite-action, constrained MDP solver can at this point be employed to find the optimal solution to the underlying task, such approach can be impractical for large tasks, due to the exponential (in the number of admissible asset health levels) number of the admissible actions. Embodiments of the present disclosure introduce a novel tractable formulation of the CMDPs with concave reward functions as a convex mathematical optimization program. Finally an extension to handle non-concave reward functions with tractable concave envelopes is presented, to broaden the applicability of the methodology covered by embodiments of the disclosure. Embodiments of the present disclosure use a convex optimization formulation for concave reward functions and extend this formulation to non-concave reward functions using their concave envelopes. The effectiveness of an approach according to embodiments of the present disclosure is demonstrated on the task of managing delinquencies in a portfolio of loans.

### 1. Introduction

In the absence of interventions, a loan is assumed to transition from one delinquency level to another across time periods according to an exogenous base transition probability. This transition probability can, however, be controlled by taking various intervention actions, the cost of which depends on the deviation from the base transition probability. The overall objective in managing such a loan portfolio is to choose interventions that maximize the expected financial gain of a loan servicing operator, or equivalently to minimize its loan servicing cost, subject to some constraints on the expected performance of loan portfolio. These performance constraints are motivated by both regulatory and business reasons, and are typically in terms of acceptable bounds on the expected percentage of loans that would result in a default (the most delinquent level) at the end of a planning horizon, or at various intermediate time periods. While this disclosure focuses specifically on loans, models and results according to embodiments of the disclosure are applicable to other domains, such as maintenance scheduling, debt collection, and marketing.

A target probability distribution of portfolio asset health levels is a function of the starting probability distribution of portfolio asset health levels times the stage dynamics of asset health levels (exogenous+interventions). The target probability distribution of portfolio asset health levels is a polynomial of degree K, and the intermediate-stage constraints on asset health levels are also high-degree polynomials. It is challenging to solve for the target probability distribution using a standard polynomial approach. Ad-hoc investment strategies are focused primarily on meeting operation targets without considering extra resource cost. An approach that optimizes only a current stage, then moves to next stage, optimizes that stage etc. is not optimal and leads to fluctuations of investments. In addition, an approach that employs finite action constrained Markov decision processes is inadequate due to the continuous nature of applicable actions (investments). Approaches based on robust Markov decision processes do not handle constraints on asset health level occupancy probabilities. An approach based on reinforcement learning only finds approximate policies.

To determine the right sequence of such interventions, one needs to solve a stochastic dynamic decision process. Note that it suffices to optimize the sequence of interventions independently for each loan, since all important metrics, such as decision making objectives and constraints, are expressed in terms of expectations. For each decision period t one may assume a finite set of states Sₜ that represent the various levels of loan delinquency for the period t. For any loan state sₜεSₜ, let b(sₜ) denote the base transition probability distribution over the finite support Sₜ₊₁. The decision-maker can modify b(sₜ) into any probability distribution p(sₜ) that belongs to a set Pₛₜ of feasible distributions. In other words, p(sₜ) is the modulated or changed transition probability to other delinquency states Sₜ₊₁ after an intervention corresponding to sₜ. The cost of achieving this modulation may be assumed to be a function of the difference, p(sₜ)−b(sₜ).

Given the chosen interventions, let d(s) represent the probability of visiting state sεS_{T} in time period T following a sequence of T−1 interventions. In vector notation:

d=α^{T}P₁, P₂ . . . P_{T-1},

where α is an initial probability distribution over the finite set S_{I} and Pₜ=[p(sₜ)]ₛ_{ₜ}_{εS}_{ₜ} is the transition probability matrix induced by the interventions. The portfolio performance constraints require that for some selected states s and values q(s), d(s)<q(s). Note that d is a complex polynomial function of the decisions p. Consequently, the total expected costs corresponding to a sequence of T−1 interventions and transitions, as well as the performance constraints are nonconvex polynomials of degree |T−1|. Because non-convex polynomial optimizations are usually very challenging to solve, this direct formulation is unlikely to lead to a tractable solution.

To derive tractable algorithms, embodiments of the disclosure may cast the optimization task as an instance of a constrained Markov decision process (CMDP). The MDP states in a formulation according to embodiments of the disclosure represent the levels of a loan delinquency and the actions represent the available interventions. According to embodiments of the disclosure, the performance constraints can then be conveniently represented in the CMDP framework. While CMDPs with small state and action sets can easily be formulated and solved as linear programs, the loan delinquency management task has a continuous action set: the available interventions can continuously adjust the transition probabilities between different states.

### 2. Framework

This section first describes the constrained Markov decision processes with continuous modulation of transition probabilities and their basic properties, and then briefly discusses a CMDP formulation of the loan management task.

Let Δⁿ denote a set of probabilities in [symbol] ⁿ: Δⁿ={pε [symbol] ⁿ:1^{T}p=1}; this represents the set of all probability distributions over n elements. Let 0, 1, I denote a vector of all zeros, all ones, and an identity matrix respectively; their sizes being given by the context.

First, define an abstract finite-horizon constrained Markov decision process (CMDP) M with continuously modulated transition probabilities. The finite time horizon is assumed to be: t=1, . . . , T. The finite state set at time t is denoted as Sₜ and the set of all states is S=∪_{t=1 . . . T}Sₜ•. The underlying base transitions probability from any state sₜεSₜ is b(sₜ)εΔ^{|S}^{ₜ₊₁}^{|}; that is the vector of transition probabilities from some sₜ to any sₜ₊₁εSₜ₊₁, when no action is taken. The infinite continuous actions space for any sₜεSₜ is denoted as A(sₜ). The set A(sₜ) should be compact and satisfies A(sₜ)⊂Δ^{|S}^{ₜ₊₁}^{|} and b(sₜ)εA(sₜ). The compactness assumption according to an embodiment of the disclosure can ensure that all optima are achieved. An action aₜεA(sₜ) for sₜεSₜ denotes the modulated transition probability distribution over sₜ₊₁εSₜ₊₁. The rewards are denoted as: r(sₜ, a) for state sₜ and action a. The initial probability distribution is: αεΔ^{|S}^{₁}^{|}. Finally, a solution according to an embodiment of the disclosure should satisfy quality constraints such that the visitation probability for states in Qᵢ⊂S are bounded by qᵢ for some indices iεI.

Next, the known properties of the optimal solutions of CMDPs with continuous actions are summarized. Similar to unconstrained MDPs, there exists an optimal Markov policy π under some mild assumptions, but this policy may need to be randomized. The set of randomized Markov policies is Π_{R}={π:S→Δ^{|A|}}. A randomized policy assigns a probability distribution of actions to each state of a Markov process. Note that the existence of an optimal policy requires that the action space is compact. A Markov policy is deterministic when the action distribution is degenerate; the set of deterministic policies is Π_{D}={π:S→A}, i.e., a deterministic policy assigns an action to each state of a Markov process.

Definition 2.1. The objective of the optimization is:

$${max}_{π ∈ {Π}_{R}} E [ {\sum }_{t = 1}^{T - 1} r ( {S}_{t} , π ( {S}_{t} ) ) ] s . t . {\sum }_{{t = 1 , … T}_{s ∈ {Q}_{i}}} P [ {S}_{t} = s ] \leq {q}_{i}$$

for all iεI where Sₜ are state-(Sₜ)-valued random variables and the constraints ensure the desired solution quality.
Remark 2.2. Unlike regular MDPs, there may not be any uniformly optimal policy in a CMDP regardless of the initial state. The initial distribution is thus a part of the CMDP definition.

In the remainder of the disclosure, sums will be used even when integrals should be used for the continuous action space. Formally, one could replace all the sums by Lebesgue integrals.

A value function for a given policy uniquely determines for each state s the total, i.e. over all the future decision epochs, reward in expectation that the process will collect if started from the state s. A joint state action probability specifies the probability distribution according to which each action, from some set of admissible actions, will be executed from state s, for all states s of the process. For example, suppose there are only two states, s1 and s2, and three actions, a1, a2, a3, so that each action can be executed from each state. A joint state-action probability function for state s1 would prescribe the probability with which a1 will be executed in s1, the probability with which a2 will be executed in s1 and the probability with which a3 will be executed in s1.

For each policy πεΠ_{R}, let u_{π}(sₜ,a)ε[0,1] denote a joint state action visitation probability, and d_{π}(sₜ)ε[0,1] denotes the state visitation probability. Using these terms, the return of a policy π can be written as:

$$ρ ( π ) = {\sum }_{t = 1}^{T} {\sum }_{{{s}_{t} ∈ {S}_{t}}_{{a}_{t} ∈ A ( {s}_{t} )}} r ( {s}_{t} , {a}_{t} ) \cdot {u}_{π} ( {s}_{t} , {a}_{t} ) \qquad ( 2.1 )$$

where u_{π} is uniquely determined by the following constraints:

$$\begin{matrix}{\sum }_{{a}_{t} ∈ A ( {s}_{t} )} {u}_{π} ( {s}_{t} , {a}_{t} ) = {d}_{π} ( {s}_{t} ) & ( 2.2 ) \\ {\sum }_{{s}_{t} , {a}_{t}} {u}_{π} ( {s}_{t} , {a}_{t} ) \cdot {a}_{t} ( {s}_{t + 1} ) = {d}_{π} ( {s}_{t + 1} ) & ( 2.3 ) \\ {d}_{π} ( {s}_{t} ) = a ( {s}_{1} ) & ( 2.4 ) \\ \frac{{u}_{π} ( {s}_{t} , {a}_{t} )}{{d}_{π} ( {s}_{t} )} = π ( {s}_{t} , {a}_{t} ) & ( 2.5 )\end{matrix}$$

where it is assumed that sₜεSₜ,aₜεA(sₜ),aₜ₊₁εA(sₜ₊₁) in EQ. (2.3) and the constraint must hold for each t and sₜ₊₁. Note that these constraints imply that u≧0.

A meaning of the above constraints according to embodiments of the disclosure may be understood as follows. The constraint of EQ. (2.2) states that the state visitation probability is simply s marginalized state-action visitation probability. The constraint of EQ. (2.3) may be a flow conservation constraint that denotes that the probability of transitioning to state sₜ₊₁ from any state sₜ is equal to the probability of visiting the state. Note that aₜ in EQ. (2.3) is a vector of transition probabilities. The constraint of EQ. (2.4) ensures that the initial probabilities are correct and finally, the constraint of EQ. (2.5) ensures that the actions are taken with the probabilities specified by the policy π.

The return in EQ. (2.1) is maximized over policies that satisfy the quality constraints of the CMDP:

Σ_{sεQ}_{ᵢ}d_{π}(s)≦qᵢ

for all i.

In the remainder of the disclosure, π(s)=a denotes a deterministic policy that chooses a with probability 1 and π(s,a) denotes a probability of taking an action a. Finally, π(s) denotes the vector of action probabilities for a stochastic policy.

The constraints in a CMDP according to an embodiment of the disclosure make it more challenging to solve than a regular MDP. In particular, standard MDP solution methods, such as value iteration and policy iteration cannot be used. The main reason is that, as noted in Remark 2.2, the optimality of a policy may depend on the initial distribution. Therefore, the optimal value function cannot be computed without a reference to the initial distribution. Constrained MDPs may be solved using an extended linear program formulation of an MDP.

A CMDP according to an embodiment of the disclosure with continuous probability modulations is more challenging to solve than a regular CMDP because of the continuous action sets. Methods according to embodiments of the disclosure can solve a continuous-action CMDP when the reward function satisfies certain properties. In particular, if the rewards are affine, a continuous-action CMDP according to an embodiment of the disclosure can be reduced to a CMDP with a finite number of actions. More generally, when the rewards are concave, there exists a tractable convex formulation according to an embodiment of the disclosure, and there may exist a tractable formulation according to an embodiment of the disclosure even when the rewards are non-concave.

The loan management task can be formulated as a CMDP as follows. As mentioned above, the evolution of each individual loan can be formulated independently from each other. Let the possible delinquency states be from a set D. Assume, in addition, that the loan size is one of discrete levels from set L; the value of loan may change as its state evolves and can be used to determine the cost of a default. The MDP states are then defined as:

Sₜ={(t,s,l):sεD,lεL} t=1 . . . T._{:}

When no intervention is taken, a loan can transition between the states according to a base transition probability b(sₜ) for each sₜεSₜ.

In the context of a loan portfolio, a state corresponds to a “delinquency level×a certain point in time”. For example, if a loan is in a state “60_days_Delinquent_&_month_{—}7/2013”, it means that it is 60 days_delinquent and the current month is 7/2013. From that state a loan could for example transition to a state “60_days_Delinquent_&_month_{—}8/2013” or “90_days_Delinquent_&_month_{—}8/2013” or “0_days_Delinquent_&_month_{—}8/2013”. A method according to an embodiment of the disclosure does not consider individual loans occupying different states, but rather, the percentage of the whole loan portfolio that occupies a given state. For example, say at a given month T, A % of loan are 0 days delinquent, B % of the loans are 30 days delinquent, C % of the loans are 60 days delinquent, etc. The process is then in state “0_days_Delinquent_T” with probability A, in state “30_days_Delinquent_T” with probability B and in state “60_days_Delinquent_T” with probability C.

An action is a transition probability chosen (from a given range) from one state to another. A policy is then a set of actions prescribed for all of the states. For example, a policy in the loan delinquency domain would prescribe an action, i.e. transition probabilities to all other states, to all states, that is, to all delinquency levels at all decision epochs (e.g. months). By a continuously modulated transition probability is meant that a model according to an embodiment of the disclosure may allow for a transition probability from state s to s′ to be any real value between some limiting values, e.g., 0.1 and 0.2. A transition probability anywhere in this [0.1, 0.2] range selected by an algorithm according to an embodiment of the disclosure may be referred to as a modulation.

The transitions represent both the change in the delinquency state and the loan value. The interventions modify base transition probabilities to reduce the probability of the delinquency. The feasible actions considered according to embodiments of the disclosure are A(sₜ={pεΔ^{S}^{ₜ₊₁}:∥p−b(sₜ)|∞≦ε}; that is, the difference from the base transition probability is bounded element-wise. Each intervention has a cost associated with it. The costs are convex and piecewise linear convex in the scope of the transition probability modulation and may correspond to a weighted version of ∥a−b(sₜ)∥₁ for an action a for each state sₜ. Rewards correspond to negative costs and are, therefore, concave

3. CMDPs with Affine Rewards

This section shows that a continuous action can be reduced to a finite number when (1) the rewards are affine in the constrained MDP, and (2) the action set A(s) are polytopes for every sεS. In particular, there exists an optimal (randomized) policy that only takes actions that correspond to the extreme points of the polytope A(s).

Assumption 1. The reward r(s; a) is an affine function of aεA(s) for every sεS:

r(s,a)=eₛ^{T}α+ƒₛ

for some eₛ and ƒₛ.

To construct a finite-action CMDP from a continuous action CMDP, assume an CMDP M₁ with continuous action sets as defined in section 2. A standard constrained MDP M₂ may be constructed with a state space identical to M₁ and actions defined as:

A̅(s)=ext(A(s)),

for each sεS where ext denotes the extreme points of the set.

That is, the actions in M₂ also define the actual transition probabilities as in M₁; except the actions are restricted to the subset Ā(s). The reward function M₂ is identical to the reward function in M₁. By definition, Ā(s) is finite when A(s) is a polytope. As will be shown next, the optimal return in MDP M₂ equals the optimal return in M₁ given mild assumptions.

Theorem 3.1. Assume that A(s) is a polytope and that Assumption 1 holds. Then, the optimal returns in MDP M₁ and M₂ are identical. In addition, for any optimal policy π₂* in M₂ there exists a deterministic policy π₁* in MDP M₁ with the same return.

First, to prove Theorem 3.1 it needs to be shown that there exists an optimal deterministic policy for the CMDP M₁ when the reward function is concave (or affine).

Lemma 3.2. Assume that the function r(s, a) is concave in a and A(s) is convex for each sεS. Then, there exists an optimal deterministic policy π* in M₁.
Proof. Assume there exits an optimal randomized policy π₀εΠ_{R}, and show that there exists a deterministic policy π₁εΠ_{D} such that ρ(π₀)=ρ(π₁). The policy π₁ is constructed as:

$${π}_{1} ( s ) = {\sum }_{a ∈ A ( s )} {π}_{0} ( s , a ) \cdot a ,$$

for each sεS, which is feasible from the convexity of A(s). Note that a is vector in this equation; that is the action π₁ is a convex combination of elements of A(s). The action π₁(s) is in A(s) from because this is a convex set and π₁(s) is a convex combination of the elements of the set. Using EQS. (2.3) and (2.4) the state visitation probabilities of π₁ and π₂ are the same: d_{π}_{₀}=d_{π}_{₁}. Using this equality and the concavity of r:

r_{π}_{₁}(s)=r(s,π₁(s))=r(s,π_{aεA(s)}π₀(s,a)·a)≧Σ_{aεA(s)}π₀(s,a)r(s,a)=r_{π}_{₀}(s)

It readily follows that the transition probabilities under π₀ and π₁ are identical and therefore ρ(π₁)≧ρ(π₀)•. The lemma then follows from the optimality of π₀ and from the monotonicity of the Bellman operator. The monotonicity of the Bellman operator implies that uniformly increasing the rewards also increases the return.
Proof of Theorem 3.1. Let πᵢ* and ρᵢ* be the optimal policy and return in Mᵢ respectively. The equality ρ₁=ρ₂ can be shown in two steps; first, show that ρ₂*≧ρ₁*. From Lemma 3.2, there exists a π₁* that is deterministic. Now create a randomized policy π₂ in M₂ that satisfies, for each sεS:

$${\sum }_{\overline{a} ∈ \overline{A} ( s )} {π}_{2} ( s , \overline{a} ) \cdot \overline{a} = {π}_{1}^{*} ( s ) \qquad ( 3.1 )$$

There always exists a unique π₂ that satisfies the above condition since Ā=ext(A) and A(s) is convex: each point in a polytope is a unique convex combination of its extreme points. The condition of EQ. (3.1) also guarantees that the transitions probabilities for π₁* and π₂ are the same.

It remains to show that the rewards for π₁* and π₂ equal:

$$\begin{matrix}{r}_{{π}_{2}} ( s ) = {\sum }_{\overline{a} ∈ \overline{A} ( s )} {π}_{2} ( s , \overline{a} ) \cdot r ( s , \overline{a} ) \\ = {\sum }_{\overline{a} ∈ \overline{A} ( s )} {π}_{2} ( s , \overline{a} ) \cdot ( {e}_{s}^{T} \overline{a} + {f}_{s} ) \\ = {e}_{s}^{T} ( {\sum }_{\overline{a} ∈ \overline{A} ( s )} {π}_{2} ( s , \overline{a} ) \cdot \overline{a} ) + {f}_{s} \\ = {e}_{s}^{T} {π}_{1}^{*} ( s ) + {f}_{s} \\ = {r}_{{π}_{1}^{*}} ( s )\end{matrix} \qquad ( 3.2 )$$

using EQ. (3.1) for π₂ and Assumption 1. The monotonicity of the Bellman operator then implies that ρ₂*≧ρ₂≧ρ₁*.

Now it may be shown that ρ₁*≧ρ₂*. Let ρ₂* be an optimal randomized policy in M₂. Define a deterministic policy π₁ as follows:

$${π}_{1} ( s ) = {\sum }_{\overline{a} ∈ \overline{A} ( s )} {π}_{2}^{*} ( s , \overline{a} ) \cdot \overline{a} . \qquad ( 3.3 )$$

Note that EQ. (3.3) represents a convex combination of individual action vectors. It can be shown from EQ. (3.3) that the transition probabilities for policies π₂* and π₁ are the same. Next, show that r_{π}_{₁}(s)≧r_{π}_{₂}_{*}(s):

$$\begin{matrix}{r}_{{π}_{2}^{*}} = {\sum }_{\overline{a} ∈ \overline{A} ( s )} {π}_{2}^{*} ( s , \overline{a} ) \cdot r ( s , \overline{a} ) \leq r ( s , {\sum }_{\overline{a} ∈ \overline{A} ( s )} {π}_{2}^{*} ( s , \overline{a} ) \cdot \overline{s} ) \\ = r ( a , {π}_{1} ( s ) ) \\ = {r}_{{π}_{1}} ( s ) ,\end{matrix}$$

using the concavity of the reward function. The monotonicity of the Bellman operator implies that ρ₁*≧ρ₂*. This shows the required equality and the necessary policies can be constructed as defined in EQS. (3.2) and (3.3). ▪

Note the reward function should be linear. This limitation can be relaxed by extending the results to rewards that are piecewise linear and concave by considering the extreme points of the hypograph of this function. In addition, the number of actions in this formulation is finite, but may be very large; in the worst case, the number of the finite actions may be exponential in the number of states even when A is specified by a polynomial number of linear constraints.

4. CMDPs with Concave Rewards

This section describes a direct formulation of the CMDP according to an embodiment of the disclosure as a convex mathematical optimization task. A formulation according to an embodiment of the disclosure can relax the necessary assumptions on the MDP structure compared to Theorem 3.1 and can lead to a tractable algorithm.

According to an embodiment of the disclosure, the reward function r:Sₜ×Δ^{|S}^{ₜ₊₁}^{|} [symbol] may be extended to r:Sₜ× [symbol] ₊^{|S}^{ₜ₊₁}^{|}→ [symbol] which also assigns rewards for actions that are not valid distributions. An extended function r̅(s. a) according to an embodiment of the disclosure may be defined as:

$$\overline{r} ( s , a ) = {1}^{T} a \cdot r ( s , \frac{a}{{1}^{T} a} ) .$$

where r̅(s,0)=0. Note that this function is positively homogeneous: that is, r̅(s, q·a)=q·r(s, a) for q≧0. This transformation also preserves the convexity or concavity of the reward function as the following lemma states.
Lemma 4.1. For each sₜεSₜ, the function

$$\overline{f} ( a ) = {1}^{T} a \cdot f ( \frac{a}{{1}^{T} a} )$$

is concave (convex) on [symbol] ^{|S}^{ₜ₊₁}^{|} if and only if ƒ(a) is concave (convex) on Δ^{|S}^{ₜ₊₁}^{|}.
Proof. This is a standard result which can be readily shown directly from the definition of concavity (convexity) for q·ƒ(x/q) for q≧0. Assume any non-negative α+β=1, then:

$$\begin{matrix}( α {q}_{1} + β {q}_{2} ) \cdot f ( \frac{α {x}_{1} + β {x}_{2}}{α {q}_{1} + β {q}_{2}} ) = = ( α {q}_{1} + β {q}_{2} ) \cdot f ( \begin{matrix}\frac{α {x}_{1} {q}_{1}}{α {q}_{1} + β {q}_{2}} \frac{{x}_{1}}{{q}_{1}} + \\ \frac{β {x}_{2} {q}_{2}}{α {q}_{1} + β {q}_{2}} \frac{{x}_{2}}{{q}_{2}}\end{matrix} ) \\ = = α {q}_{1} \cdot f ( \frac{{x}_{1}}{{q}_{1}} ) + β {q}_{2} \cdot f ( \frac{{x}_{2}}{{q}_{2}} )\end{matrix}$$

The lemma then follows from the restriction of q=1^{T}x. ▪

Some examples of extended functions according to embodiments of the disclosure are presented below.

### Example 4.2

Assume that the reward is linear: r(s, a)=eₛ^{T}a+ƒₛ. Then, the extended reward function is:

r̅(s,a)=eₛ^{T}a+1^{T}a·ƒₛ

### Example 4.3

Assume that the reward is defined by a norm: r(s,a)=−∥a−āₛ∥. Then, the extended reward function is:

r̅(s,a)=−∥a−1^{T}a·āₛ∥

### Example 4.4

Assume that the reward is defined by a squared L₂ norm: r(s,a)=−∥a−āₛ∥₂². Then, the extended reward function is:

$$\overline{r} ( s , a ) = - \frac{1}{{1}^{T} a} {‖ a - {1}^{T} a \cdot {\overline{a}}_{s} ‖}_{2}^{2} .$$

Constrained MDPs are typically solved using a linear program formulation based on the state-action visitation probabilities u as the optimization variables. Such formulation may lead to a semi-infinite optimization task because of the continuous action space and the need to have a decision variable for each state and action pair. According to an embodiment of the disclosure, decision variables u(sₜ, sₜ₊₁) are used, which represent the joint probability of visiting sₜ and transitioning to sₜ₊₁. State visitation probabilities d(sₜ) can be derived from these variables by marginalizing over sₜ₊₁ similar to EQ. (2.2).

A formulation according to an embodiment of the disclosure based on the decision variables u(sₜ, sₜ₊₁) should ensure that the corresponding transition probabilities represent feasible actions in A(s). Let the notation u(sₜ,) represents the vector of values indexed by the second argument. Then, the vector of transition probabilities from state sₜ is u(sₜ, _)/d(sₜ) which is feasible in A(sₜ). The constraints u(sₜ, _)/d(sₜ)εA(sₜ) are non-linear and non-convex in the state visitation probabilities d(sₜ). Therefore, a direct formulation would be non-convex and challenging to solve.

According to an embodiment of the disclosure, to derive a convex formulation, let A(sₜ) be a convex set defined by convex constraints for sₜεSₜ:

A(sₜ)={aεΔ^{|S}^{ₜ₊₁}^{|}:fₛ_{ₜ}^{j}(a)≦0,jεJ}

for some ƒₛ_{ₜ}^{j}. The feasibility constraints on the transition probabilities that should be satisfied by the solution u then become:

$${f}_{s}^{j} ( \frac{u ( s , )}{d ( s )} ) \leq 0. \qquad ( 4.1 )$$

This function is non-convex in d(s) and, therefore, cannot be used to formulate a convex optimization task. To get an identical but convex constraint, first define an extended constraint function:

$${\overline{f}}_{s}^{j} ( a ) = {1}^{T} a \cdot {f}_{s}^{j} ( \frac{a}{{1}^{T} a} ) ,$$

where by definition ƒ̅ₛ_{ₜ}^{j}(0)=0. Note that d(s)=1^{T} u(s, ). The constraint of EQ. (4.1) can be multiplied by d(s) to get the constraint:

$$d ( s ) \cdot {f}_{s}^{j} ( \frac{u ( s , )}{d ( s )} ) = {\overline{f}}_{s}^{j} ( u ( s , ) ) \leq 0. \qquad ( 4.2 )$$

The function ƒ̅ₛ_{ₜ}^{j} is convex from Lemma 4.1 and the constraint of EQ. (4.2) is equivalent to EQ. (4.1) since d(s)≧0 and u(s, )=0 whenever d(s)=0.

An optimization according to an embodiment of the disclosure that can be used to compute the optimal policy in CMDPs may be formulated as follows:

$$\begin{matrix}{max}_{u \geq 0 , d \geq 0} & {\sum }_{s ∈ S} \overline{r} ( s , u ( s , ) ) & \\ s . t . & d ( {s}_{1} ) = α ( {s}_{1} ) & ∀ {s}_{1} ∈ {S}_{1} \\ & d ( {s}_{t} ) = {\sum }_{{s}_{t + 1}} u ( {s}_{t} , {s}_{t + 1} ) & \\ & d ( {s}_{t} ) = {\sum }_{{s}_{t - 1}} u ( {s}_{t - 1} , {s}_{t} ) & \\ & {\sum }_{s ∈ {Q}_{i}} d ( s ) \leq {q}_{i} & i ∈ I \\ & {\overline{f}}_{s}^{j} ( u ( s , ) ) \leq 0 , & j ∈ J\end{matrix} \qquad ( 4.3 )$$

Each sₜ is implicitly considered to be in Sₜ and each s is implicitly considered to be in S. Note that:

$${\sum }_{s ∈ S} \overline{r} ( s , u ( s , ) ) = {\sum }_{s ∈ S} d ( s ) \cdot r ( s , \frac{u ( s , )}{d ( s )} ) .$$

The formulation in EQS. (4.3) reduces to a linear program when the sets of feasible actions are polytopes as the following example shows.

A meaning of the constraints in EQS. (4.3) according to embodiments of the disclosure may be the same as in EQS. (2.2) to (2.5). The main difference from a standard LP formulation is the objective function, which is expressed in terms of an extended reward function according to an embodiment of the disclosure, and the last constraint, which is expressed in terms of extended action constraint functions according to embodiments of the disclosure. An optimal policy π* according to an embodiment of the disclosure can be extracted from the optimal solution u*, d* according to Theorem 4.6.

### Example 4.5

Assume that the set of feasible actions is a polytope for each sₜεSₜ:

A(s)={aεΔ^{|S}^{ₜ₊₁}^{|}:Hₛa≦hₛ},

where Hₛ and hₛ are a matrix and vector that specify all constraints of the set of feasible actions. Then, the constraints ƒ̅ₛ^{j}(a)≦0 for all jεJ become:

$${1}^{T} a \cdot {H}_{s} \frac{a}{{1}^{T} a} \leq {1}^{T} a \cdot {h}_{s} , \\ {H}_{s} a \leq {1}^{T} a \cdot {h}_{s}$$

which is a set of linear constraints.

The following theorem states the correctness of the formulation of EQS. (4.3).

Theorem 4.6. Assume that, for each SεS, r(s, a) is concave in a and that the set A(s) is convex. Let u*, d* be optimal solutions of EQ. (4.3) and define a deterministic policy π:

π(s)=u*(s,)/d*(s).

That is, π(s) maps a state to a vector of state transition probabilities. Then, π is an optimal policy and the objective value of EQS. (4.3) equals to ρ(π). In addition, EQS. (4.3) is a convex optimization task.
Proof First, show that the optimal policy π* is feasible in EQ. (4.3) and the corresponding objective value equals the return of the optimal policy π*. Given an optimal deterministic policy π* (from Lemma 3.2), construct a solution u, d in EQ. (4.3) as u(s, )=d(s)·π*(s). It is known that there is a unique solution to all but the last constraint of EQ. (4.3). As described above, this constraint is valid from EQS. (4.1) and (4.2) because d≧0. Therefore, Σ_{sεS} r̅(s, u*(s, ))≧ρ(π). The reverse inequality

$${\sum }_{s ∈ S} \overline{r} ( s , u * ( s , ) ) \leq ρ ( π )$$

can be shown similarly by constructing a feasible policy from any solution u, d using the construction from the statement of the theorem. The convexity of the optimization problem follows from Lemma 4.1. ▪

The computational complexity of solving EQ. (4.3) depends on the form of r̅; the task is tractable for most common concave functions. In particular, EQ. (4.3) is tractable for concave piecewise linear functions and concave quadratic functions. Note that this formulation generalizes the setting in Section 3 and has a smaller computational complexity.

5. CMDPs with Non-Concave Rewards

This section describes how to tractably solve CMDPs with non-concave reward functions. An approach according to an embodiment of the disclosure relies on the fact that the optimal return of any constrained MDP is unaffected if the rewards are replaced by their concave envelope, thereby obtaining a concave maximization task.

The concave envelope g(x) of a function f(x) is defined as:

g(x)=sup {t:(x,t)εconv hypo r(s,x)}

where conv is the convex hull and hypo is the hypograph of f. A hypograph of f is defined as: hypo f={(x, t): t<=f(x)}. The supremum above is achieved whenever f is bounded and A are compact, which are assumptions according to an embodiment of the disclosure. A concave envelope is important because it is the smallest concave function that is greater than f.

### Example 5.1

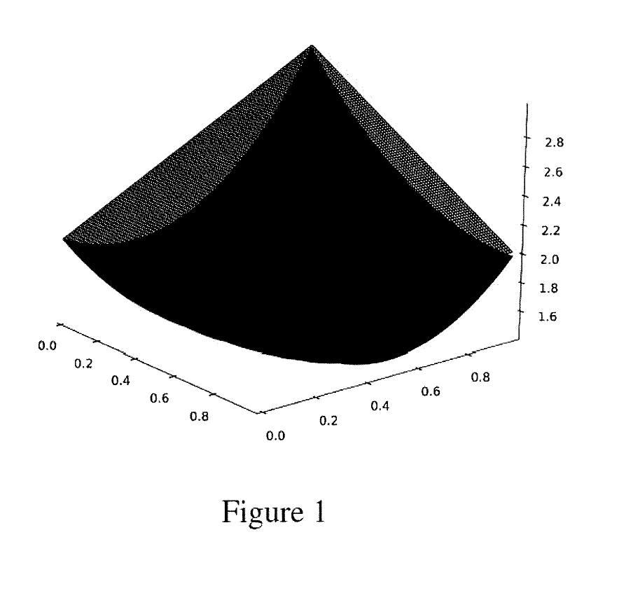

Consider a function ƒ(x, y)=x²+2 y²−x y+2−x−y defined on the interval [0; 1]×[0; 1]. The concave envelope of this convex function is the piecewise linear concave function g(x, y)=min{y+2, −x+3}. FIG. 1 shows a convex function ƒ and its concave envelope g.

Assume a CMDPM with a reward function r and construct a CMDP Mₑ with a reward r^{e} that is the concave envelope of r for each sεS:

r^{e}(s,a)=sup{t:(x,t)εconv hypo r(s,x)},

where hypo is over A(s). Let ρ(π) and ρₑ(ρ) be the returns of π in M and Mₑ respectively.

A motivation for considering a concave envelope of the rewards is that the transition probabilities with this reward can be achieved by appropriately randomizing the policy. The following example shows this property.

### Example 5.2

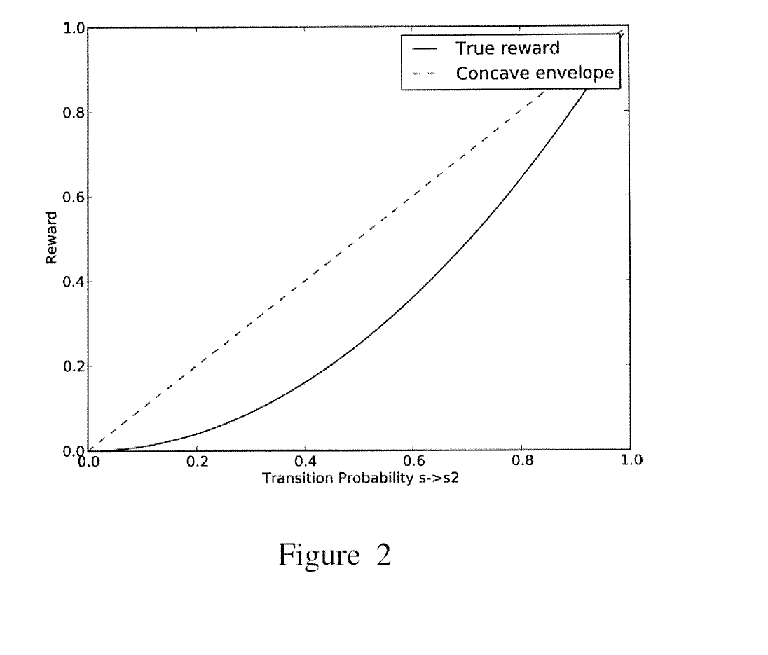

Consider a state s with transitions to two other states s₁ and s₂ with continuous modulation of probabilities in the set A(s)=Δ². For any action a, let a₁ and a₂ represent the transition probabilities to states s₁ and s₂ respectively. Consider a convex reward function r(s, a)=a₂² and its concave envelope rₑ(s, a)=a₂ depicted in FIG. 2. To show that an optimal policy will be randomized between the extreme points, assume for example that an optimal policy has a transition probability (0.6, 0.4). Directly taking an action (0.6, 0.4) accrues a reward 0.4²=0.16. However, taking action (0, 1) with probability 0.4 and action (1, 0) with probability 0.6 accrues a higher reward of 0.4. In general, according to an embodiment of the disclosure, a maximal reward for each transition probability can be achieved by a maximal convex combination of other feasible actions which yield the concave envelope.

The CMDP M cannot be solved using EQ. (4.3) because of the non-concave rewards. On the other hand, because the rewards in Mₑ are concave, it can be formulated as EQ. (4.3). Note, however, that an optimal solution of Mₑ is not necessarily optimal in M. The following theorem states that an optimal solution for M can be constructed from an optimal solution to Mₑ by appropriately randomizing between the extreme points of the concave envelope.

Theorem 5.3. Let πₑ* be an optimal policy in CMDP Mₑ. Then, one can construct an optimal policy π* in M such that (1) ρₑ(πₑ*)=ρ(π*); and (2) the transition probabilities π* and πₑ* are identical.
Proof. First, one may assume πₑ* to be deterministic without loss of generality from Lemma 3.2. The optimality of πₑ* and rₑ(s, a)>=r(s, a) implies that

ρₑ(πₑ*)≧ρₑ(π*)≧ρ(π*).

To show the equality, it only remains to show that ρₑ(πₑ*)≦p(π*). For any sεS, because the value r^{e}(s,) is a maximum in a closed convex hull, it is on its boundary. Therefore, for any a there exist aᵢεA(s) and λᵢε[0,1] such that:

$${r}^{e} ( s , a ) = {\sum }_{i = 1}^{m} {λ}_{i} \cdot r ( s , {a}_{i} ) ,$$

such that λ≧0, Σᵢλᵢ=1, and a=Σᵢλᵢaᵢ. Then, construct a policy π as follows:

π(s,aᵢ)=λᵢ.

It my be shown that the transition probabilities of π and πₑ* are the same, since a=Σᵢλᵢaᵢ. Then:

$${r}_{π} ( s ) = {\sum }_{i} {λ}_{i} \cdot r ( s , {a}_{i} ) = {r}^{e} ( s , a ) = {r}_{{π}_{e}^{*}}^{e} ( s ) .$$

Therefore, the rewards and transitions of π and π* are the same, which also implies ρₑ(πₑ*)≦ρ(π*). ▪

A CMDP with non-concave rewards, therefore, may be solved as follows. First, construct a concave envelope of the rewards. Then, use EQ. (4.3) to solve the new CMDP and obtain a policy πₑ*. Finally, compute the optimal π* according to the construction in the proof of Theorem 5.3. That is, any action a may be replaced by randomizing among actions aᵢ by probabilities λᵢ. The points aᵢ depend on the construction of the concave envelope. The values λᵢ can be computed by linear programming using general settings.

The tractability of a concave envelope approach according to an embodiment of the disclosure can depend on several factors. First, constructing a concave envelope is challenging in general. Second, the computed concave envelope may not have a formulation that is easily optimized. A particular case of interest is when the rewards are convex. Then, a concave envelope is piecewise linear and can be expressed in terms of the extreme points of A(s) as a linear program; it is a maximization over the convex combination of the extreme points. When the reward function is submodular on the lattice of extreme points, the envelope can be further simplified.

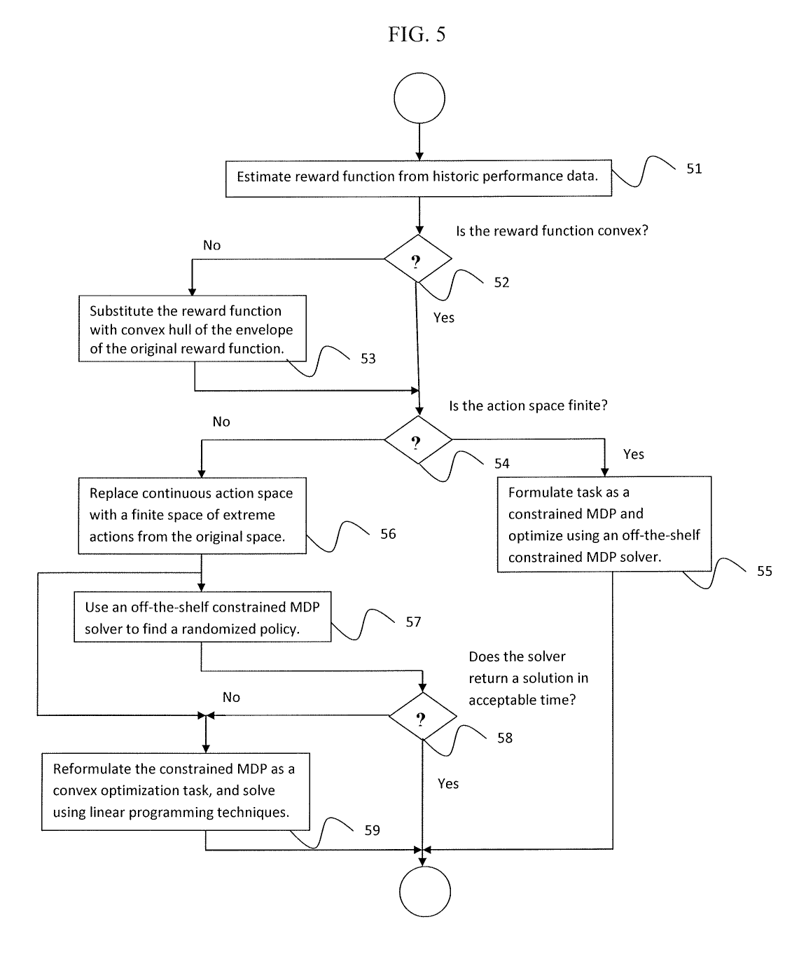

A flowchart of a method according to an embodiment of the disclosure is depicted in FIG. 5. A method according to an embodiment of the disclosure starts by estimating the reward function from historic performance data, at step 51. The inputs to step 51 is the number of assets of health level s from Sₜ that became the assets of health level s′ from Sₜ₊₁ during past decision epoch, and the total cost of modulation of the health of all the assets of health s from Sₜ to assets of health Sₜ₊₁ during past decision epoch t. The output of step 51 is a cost function r(s, a) of modulating in a decision epoch the health of an asset of health s to become (at the end of the decision epoch) an asset of health sᵢ with probability a(i), for all possible asset health levels sᵢ at the end of the decision epoch.

For example, suppose that there are three past decision epochs: d₁, d₂, d₃, and two possible asset health levels s₁ and s₂ in these decision epochs. Also, suppose that the number of assets of health level s₁ in decision epoch d₁ was N¹₁ of which N¹_{1,1} assets became assets of health s₁ and N¹_{1,2} assets became assets of health s₂ at the end of decision epoch d₁, so that N¹₁=N¹_{1,1}+N¹_{1,2}, for a modulation cost C¹₁ Also, suppose that the number of assets of health level s₁ in decision epoch d₂ was N²₁ of which N²_{1,1} assets became assets of health s₁ and N²_{1,2} assets became assets of health s₂ at the end of decision epoch d₂, so that N²₁=N²_{1,1}+N²_{1,2}, for a modulation cost C²₁. In one instance, the cost r(s,a) could be calculated as cost of loan health modulation per loan averaged over all the past decision epochs. For example, in epoch d₁, it would cost C¹₁/N¹₁ to change the asset health from s₁ to s₂ with probability N¹_{1,2}/N¹₁. Similarly, in epoch d₂, it would cost C²₁/N²₁ to change the asset health from s₂ to s₁ with probability N²_{1,2}/N²₁. In one instance, the average cost of changing the asset health from s₁ to s₂ with probability p could then be given by linear function established by using a linear regression applied to data points (C¹₁/N¹₁, N¹_{1,2}/N¹₁) and (C²₁/N²₁, N²_{1,2}/N²₁).

Next, at step 52, it is determined if the reward function is convex. If not, at step 53, the reward function is substituted with a convex hull of the envelope of the original reward function. The input to step 53 is the reward function r(s,a) of modulating, in a decision epoch, the health of an asset of health s to become, at the end of the decision epoch, an asset of health s, with probability a(i), for all possible asset health levels s, at the end of the decision epoch. The output is replacing the reward function r(s,a(i)) by its convex envelope, for each s and i:

g(x)=sup{t so that (x,t) belongs to convexHull(hypoGraph(r(a,s)))}.

For example, consider a function f(x,y)=x²+2×y²−x×y²−x−y defined on the interval [0,1]×[0,1], as shown in FIG. 1. The concave envelope of this convex function is the piecewise linear concave function g(x, y)=min {y+2, −x+3}. A method according to an embodiment of the disclosure then proceeds to step 54.

If the reward function is convex, it is determined at step 54 whether the action space is finite. If so, at step 55, the task is formulated as a constrained MDP, as follows:

the input is

t=1, 2, . . . , T decision epochs
Sₜ finite set of states at epoch t

αεΔ^{|S}^{₁}^{|} initial probability distribution

Δⁿ={pεRⁿ:1^{T}p=1} probability simplex in Rⁿ
A(sₜ)β⊂Δ^{|S}^{ₜ₊₁}^{|} infinite, compact set of actions for sₜεSₜ

aₜ εA(sₜ) modulated transition probability distribution from sₜ to sₜ₊₁εSₜ₊₁

b(sₜ)εA(sₜ) base transition probability (special case when no action taken in sₜ)

r(sₜ, a) reward for action a executed in state sₜ

(Qᵢ⊂S, qᵢ) quality constraint pair iεI:
Sum of visitation probabilities of states in Qᵢ must not exceed qᵢ
   Π_{R}={π:S→Δ^{|A|}} set of randomized policies
   Π_{D}={π:S→A} set of deterministic policies
   and the output is an objective function

$$ρ ( π ) = {\sum }_{t = 1}^{T} {\sum }_{{{s}_{t} ∈ {𝒮}_{t}}_{{a}_{t} ∈ 𝒜 ( {s}_{t} )}} r ( {s}_{t} , {a}_{t} ) \cdot {u}_{π} ( {s}_{t} , {a}_{t} )$$

in which u_{π}(sₜ, aₜ) is a probability of visiting sₜ and executing aₜ, subject to the constraints

$${\sum }_{{a}_{t} ∈ A ( {s}_{t} )} {u}_{π} ( {s}_{t} , {a}_{t} ) = {d}_{π} ( {s}_{t} ) , \\ {\sum }_{{s}_{t} , {a}_{t}} {u}_{π} ( {s}_{t} , {a}_{t} ) \cdot {a}_{t} ( {s}_{t + 1} ) = {d}_{π} ( {s}_{t + 1} ) , \\ {d}_{π} ( {s}_{1} ) = α ( {s}_{1} ) , \\ \frac{{u}_{π} ( {s}_{t} , {a}_{t} )}{{d}_{π} ( {s}_{t} )} = π ( {s}_{t} , {a}_{t} )$$

$${\sum }_{s ∈ {Q}_{i}} {d}_{π} ( s ) \leq {q}_{i} ,$$

where

$$\frac{{u}_{π} ( {s}_{t} , {a}_{t} )}{{d}_{π} ( {s}_{t} )} = π ( {s}_{t} , {a}_{t} )$$

is the policy implied by the variables of the linear program, and

$${\sum }_{s ∈ {𝒬}_{i}} {d}_{π} ( s ) \leq {q}_{i}$$

is the solution quality constraint. An off-the-shelf constrained MDP solver can be used to perform the optimization, after which the process terminates.

Otherwise, at step 56, a continuous action space is replaced by a finite space of extreme actions from the original space. The input to step 56 is the same as for step 55, and the output is that each compact and convex action polytope A(s) is replaced with a finite set A′(s) containing only the extreme actions from polytope A(s). For example, suppose that in the original task, an asset can transition from health level s₁ to s₁ with probability from a compact set [0.6, 0.9] and from s₁ to s₂ with a probability from a compact set [0.4, 0.1]. The finite set A′(s₁) of actions will then only contain actions a=(a(1), a(2)) wherein a pair (a(1), a(2)) can be one of: {(0.6, 0.4), (0.9, 0.1)}.

After the continuous action has been replaced with a finite space, an off-the-shelf constrained MDP solver can be used at step 57 to find a randomized policy. Next, at step 58, it is determined whether the solver returns a solution in acceptable time. If so, a method according to an embodiment of the disclosure terminates. If not, the constrained MDP is reformulated as a convex optimization task at step 59, and is solved using linear programming techniques.

Alternatively, after step 56, one can estimate a worse case running time based on the known number of actions and states of the underlying CMDP that describes the domain. If this estimated worse case running time is unacceptable, the constrained MDP is reformulated as a convex optimization task at step 59, as above.

The input to step 59 is the same as for step 55, and the output is the following linear program:

max_{u≧0,d≧0}Σ_{sεS} r̅(s,u(s,))

s.t. d=(s₁)=α(s₁)∀s₁εS₁,

d(sₜ)=Σₛ_{ₜ₊₁}u(sₜ,sₜ₊₁),

d(sₜ)=ρₛ_{_{t−1}}u(sₜ₋₁,sₜ),

Σ_{sεQ}_{ᵢ}d(s)≦qᵢ iεI,

ƒ̅ₛ^{j}(u(s,))≦0 jεJ,

where

$$d ( {s}_{t} ) = {\sum }_{{s}_{t} + 1} u ( {s}_{t} , {s}_{t + 1} )$$

is a joint probability of visiting sₜ and transitioning to sₜ₊₁ variables, which avoids an explicit reference to CMDP actions. The extended constraint function is

$$d ( s ) \cdot {f}_{s}^{j} ( \frac{u ( s , \cdot )}{d ( s )} ) = {\overline{f}}_{s}^{j} ( u ( s , \cdot ) ) ,$$

and the extended reward function is

$${\sum }_{s ∈ S} \overline{r} ( s , u ( s , \cdot ) ) = {\sum }_{s ∈ S} d ( s ) \cdot r ( s , \frac{u ( s , \cdot )}{d ( s )} ) .$$

### 6. Application to Loan Portfolio Management

This section describes the empirical results from an application of CMDP solution methods according to embodiments of the disclosure for both a real and a synthetic loan delinquency management problem. Methods according to embodiments of the disclosure were applied to managing the delinquencies of a loan portfolio of an actual service provider, and their impact is reported. In this example, there are 8 possible states of loan delinquency; the transition probabilities can be modulated in 4 of them. The probabilities are influenced by investing resources, such as principal reduction, in the appropriate loans. The portfolio performance targets need to be achieved within a horizon of 6 months. The ranges of possible modulations and their costs were derived from corresponding transition probabilities in prior months.

The real-world empirical study was conducted to test a global optimization method according to embodiments of the disclosure. Initially, a simple greedy algorithm was evaluated which iteratively finds an optimal modulation of probabilities in a month t assuming that the base transitions in future months will not be modified. This greedy method returned solutions characterized by high fluctuations in monthly investments in loan servicing operations. Because a method according to embodiments of the disclosure assumes no modulations after the month t, the modulations in month t were overly aggressive. In the next month t+1, the portfolio would be in a sufficiently good state to merit no further modulations. These month-to-month fluctuations are resource-intensive and undesirable. A method according to embodiments of the disclosure smoothes out these fluctuations and can result in an overall reduction of resources needed to meet portfolio targets over the whole planning horizon. Experiments on six actual loan portfolios for a time horizon of six months revealed that using an optimum method according to an embodiment of the disclosure resulted in an average 13.97% reduction in the expected costs of portfolio servicing operations in comparison with benchmark strategies used by loan managers.

Next, one may proceed with an evaluation of the solution quality and scalability of methods according to embodiments of the disclosure on a set of synthetic loan delinquency management tasks. Consider a variable number of loan delinquency states and a fixed horizon of 6 periods. The states are ordered; the increasing order represents the increasing delinquency state of a loan, such as the number of weeks behind payments. The first state represents the loan that is current and the last state represents default. The probability of increasing delinquency in a given period increases logarithmically with the current state of delinquency. In other words, accounts that are delinquent now are more likely to become more delinquent in the future. The probability of the delinquency decreasing to any less delinquent state is uniform. The feasible actions are allowed to modulate any single transition probability by at most ε=0.4. The rewards are linear in the deviation from the base probability in each element: −∥a−b∥₁. The quality constraints on the probability of the default (last state) is q=0.04.

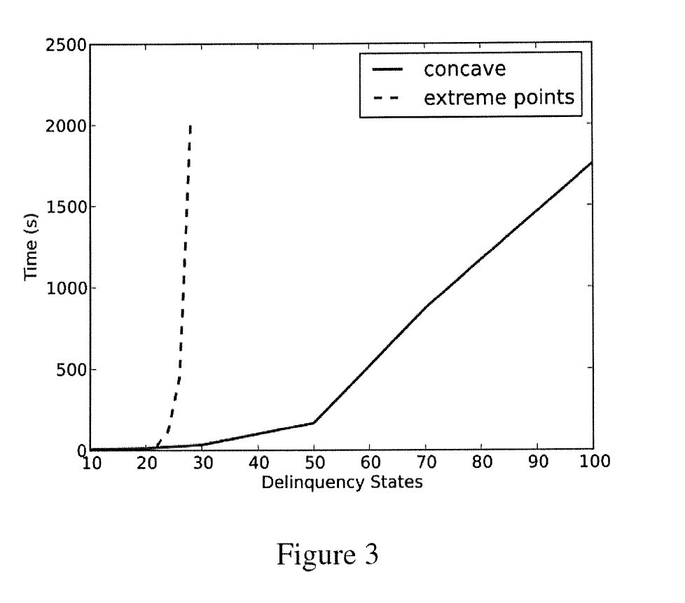

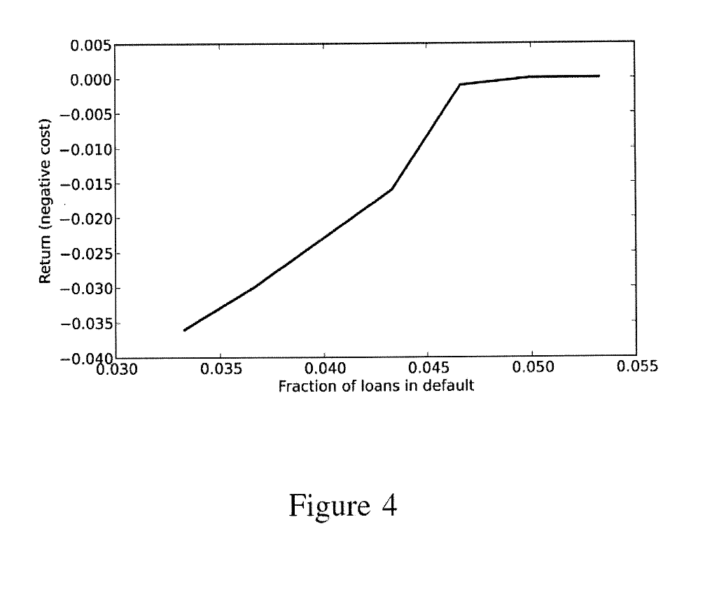

FIG. 3 compares the time to solve an CMDP using an extreme points formulation according to embodiments of the disclosure described in Section 3 versus a tractable concave method according to embodiments of the disclosure described in Section 4. The timings were obtained using CPLEX 12.5 running on an Intel Core i5 1.5 GHz processor. A tractable method according to embodiments of the disclosure scales much better with the number of states. While a concave method according to embodiments of the disclosure can solve problems with hundreds of states, an extreme-point method according to embodiments of the disclosure becomes intractable with more than 30 states. In a benchmark task, the number of extreme points grows exponentially with the number of states. The solution quality with the two methods is identical since they are both optimal. FIG. 4 graphs the return of an optimal solution as a function of the limit on the fraction of loans in default and shows the sensitivity of the return to the quality constraint; the limit on the probability of a loan to end in default.

Because the rewards may often be non-concave, an approach according to embodiments of the disclosure was evaluated assuming convex quadratic rewards ∥a−b∥₂²; which is useful when the economies of scale become important. An algorithm according to embodiments of the disclosure from Section 5 was compared with a simple naive approach which uses a linear approximation of the reward function. For the quadratic function and 30 delinquency states, an optimal method according to an embodiment of the disclosure based on a concave envelope achieves a return of 0.14, while the approximation achieves return of 0. The difference in the return between these two methods can be arbitrarily large depending on the task formulation.

### 7. System Implementations

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

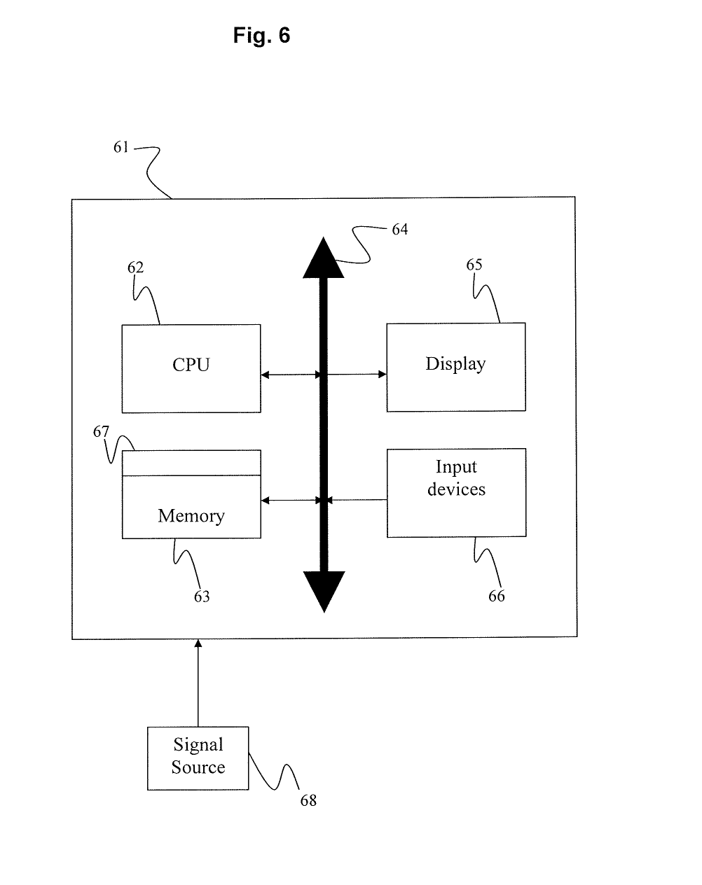

FIG. 6 is a block diagram of an exemplary computer system for implementing a method for optimal, multistage (e.g. over multiple months) management of portfolio of assets. Referring now to FIG. 6, a computer system 61 for implementing the present disclosure can comprise, inter alia, a central processing unit (CPU) 62, a memory 63 and an input/output (I/O) interface 64. The computer system 61 is generally coupled through the I/O interface 64 to a display 65 and various input devices 66 such as a mouse and a keyboard. The support circuits can include circuits such as cache, power supplies, clock circuits, and a communication bus. The memory 63 can include random access memory (RAM), read only memory (ROM), disk drive, tape drive, etc., or a combinations thereof. The present disclosure can be implemented as a routine 67 that is stored in memory 63 and executed by the CPU 62 to process the signal from the signal source 68. As such, the computer system 61 is a general purpose computer system that becomes a specific purpose computer system when executing the routine 67 of the present disclosure.

The computer system 61 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method for determining an optimal multi-stage policy that minimizes asset health modulation effort costs while satisfying asset portfolio operational targets, comprising the steps of:
providing a plurality of decision epochs and a number of admissible asset health levels, for each of the plurality of decision epochs;
providing a portfolio of assets over the admissible asset health levels in an initial decision epoch;
providing a plurality of state transition probabilities between states of an underlying asset health dynamics process, for the plurality of decision epochs, wherein each state corresponds to a percentage of the portfolio of assets that have a given asset health level in a given decision epoch;
providing an action set that includes a plurality of compact sets to which admissible actions of the state transition probabilities belong, wherein an action changes a state transition probability; and
determining cost functions of said admissible actions on a per-asset basis, wherein operational targets impose constraints on probabilities that the asset health of the portfolio of assets, in one or more decision epochs, is within a specified range.

2. The method of claim 1, wherein when the cost function is non-convex over a range of admissible actions, the method includes replacing the cost function by a convex hull of an envelope of the cost function.

3. The method of claim 2, wherein replacing the cost function by a convex hull of an envelope of the cost function comprises calculating g(x)=sup{t so that (x,t) belongs to convexHull(hypoGraph(r(a, s)))}, wherein r(a, s) is the reward function r(s,a) of modulating, in a decision epoch, the health of an asset of health s to become, at the end of the decision epoch, an asset of health s, with probability a(i), for all possible asset health levels s, at the end of the decision epoch, a hypograph of a function ƒ is defined as hypoGraph (f)={(x, t): t<=f(x)}, and sup is a supremum.

4. The method of claim 1, wherein when the costs functions are convex and the action set is finite, the method comprises determining a set of policies that optimize an expectation of the cost functions for the action set summed over all decision epochs, wherein a policy is a set of actions prescribed for all states, wherein cost functions are indexed by decision epochs and represent asset health levels in the different decision epochs, and an initial health of the asset portfolio is a probability distribution over states indexed by time 0, wherein the optimization is performed using a constrained Markov decision process solver and yields the optimal multi-stage policy as a solution.

5. The method of claim 4, wherein an expected return of the optimal multi-stage policy is
$$ρ ( π ) = {\sum }_{t = 1}^{T} {\sum }_{{{s}_{t} ∈ {S}_{t}}_{{a}_{t} ∈ 𝒜 ( {s}_{t} )}} r ( {s}_{t} , {a}_{t} ) \cdot {u}_{π} ( {s}_{t} , {a}_{t} )$$
wherein r(sₜ, aₜ) is the reward function for action aₜ being executed in state sₜ, u_{π}(sₜ, aₜ) is an probability of visiting sₜ and executing aₜ, T is the number of decision epochs, Sₜ is a set of states, A(sₜ) is the action set, subject to the constraints
$${\sum }_{{a}_{t} ∈ A ( {s}_{t} )} {u}_{π} ( {s}_{t} , {a}_{t} ) = {d}_{π} ( {s}_{t} ) , \\ {\sum }_{{s}_{t} , {a}_{t}} {u}_{π} ( {s}_{t} , {a}_{t} ) \cdot {a}_{t} ( {s}_{t + 1} ) = {d}_{π} ( {s}_{t + 1} ) , \\ {d}_{π} ( {s}_{1} ) = α ( {s}_{1} ) , \\ \frac{{u}_{π} ( {s}_{t} , {a}_{t} )}{{d}_{π} ( {s}_{t} )} = π ( {s}_{t} , {a}_{t} )$$
$${\sum }_{s ∈ {Q}_{i}} {d}_{π} ( s ) \leq {q}_{i} ,$$
wherein a(sₜ) is a state probability distribution in an initial decision epoch, π(sₜ,aₜ) is a probability of applying action aₜ to state sₜ at decision epoch t, d_{π}(sₜ) is a visitation probability for state sₜ for policy π, Qᵢ is a set of visited states, and qᵢ is a visitation probability.

6. The method of claim 1, wherein when the action set is continuous, the cost function is affine over a range of admissible modulations, and the set of actions is a polytope over the actions, the method includes:
replacing the continuous action set with a finite action set of extreme actions from the plurality of compact sets;
using a constrained Markov decision process (MDP) solver to find a randomized policy in the finite action set of extreme actions; and
converting the randomized policy into a deterministic policy that uses the admissible actions of state transition probabilities,
wherein said deterministic policy is the optimal multi-stage policy.

7. The method of claim 6, wherein, if the constrained MDP solver returns a solution in unacceptable time, the method includes reformulating the constrained MDP as a convex optimization task, and solving the convex optimization task using a linear programming solver.

8. The method of claim 7, wherein the convex optimization task is expressed as
max_{u≧0,d≧0}Σ_{sεS} r̅(s,u(s,))
s.t. d(s₁)=α(s₁)∀s₁εS₁,
d(sₜ)=Σₛ_{ₜ₊₁}u(sₜ,sₜ₊₁),
d(sₜ)=Σₛ_{_{t−1}}u(sₜ₋₁,sₜ),
Σ_{sεQ}_{ᵢ}d(s)≦qᵢ iεI,
ƒ̅ₛ^{j}u(s,))≦0 jεJ,
wherein α(s_{I}) is a state probability distribution in an initial decision epoch, S is a set of states, d(sₜ) is a visitation probability for state sₜ,
$$\overline{r} ( s , a ) = {1}^{T} a \cdot r ( s , \frac{a}{{1}^{T} a} ) .$$
is a convex reward function wherein r(s, a) is the reward function for action a being executed in state s, u(s,) is a vector of values of u(sₜ, sₜ₊₁) which is a joint probability of visiting sₜ and transitioning to sₜ₊₁, Qᵢ is a set of visited states, and qᵢ is a visitation probability,
$${\overline{f}}_{s}^{j} ( a ) = {1}^{T} a \cdot {f}_{s}^{j} ( \frac{a}{{1}^{T} a} )$$
is a convex extension of constraint set
$${f}_{s}^{j} ( \frac{u ( s , )}{d ( s )} ) \leq 0$$
which constrains action set A(sₜ) to be a convex set, and wherein optimal solutions u*, d* define a deterministic policy π(s)=u*(s,)/d*(s) that maps a state to a vector of state transition probabilities.

9. The method of claim 1, wherein the assets are loans, and the asset health levels are delinquency levels.

10. A non-transitory program storage device readable by a computer, tangibly embodying a program of instructions executed by the computer to perform the method steps for determining an optimal multi-stage policy that minimizes asset health modulation effort costs while satisfying asset portfolio operational targets, the method comprising the steps of:
providing a plurality of decision epochs and a number of admissible asset health levels, for each of the plurality of decision epochs;
providing a portfolio of assets over the admissible asset health levels in an initial decision epoch;
providing a plurality of state transition probabilities between states of an underlying asset health dynamics process, for the plurality of decision epochs, wherein each state corresponds to a percentage of the portfolio of assets that have a given asset health level in a given decision epoch;
providing an action set that includes a plurality of compact sets to which admissible actions of the state transition probabilities belong, wherein an action changes a state transition probability; and
determining cost functions of said admissible actions on a per-asset basis, wherein operational targets impose constraints on probabilities that the asset health of the portfolio of assets, in one or more decision epochs, is within a specified range.

11. The computer readable program storage device of claim 10, wherein when the cost function is non-convex over a range of admissible actions, the method includes replacing the cost function by a convex hull of an envelope of the cost function.

12. The computer readable program storage device of claim 11, wherein replacing the cost function by a convex hull of an envelope of the cost function comprises calculating g(x)=sup{t so that (x,t) belongs to convexHull(hypoGraph(r(a, s)))}, wherein r(a, s) is the reward function r(s,a) of modulating, in a decision epoch, the health of an asset of health s to become, at the end of the decision epoch, an asset of health s, with probability a(i), for all possible asset health levels s, at the end of the decision epoch, a hypograph of a function ƒ is defined as hypoGraph (f)={(x, t): t<=f(x)}, and sup is a supremum.

13. The computer readable program storage device of claim 10, wherein when the costs functions are convex and the action space is finite, the method comprises determining a set of policies that optimize an expectation of the cost functions for the action set summed over all decision epochs, wherein a policy is a set of actions prescribed for all states, wherein cost functions are indexed by decision epochs and represent asset health levels in the different decision epochs, and an initial health of the asset portfolio is a probability distribution over states indexed by time 0, wherein the optimization is performed using a constrained Markov Decision Process solver and yields the optimal multi-stage policy as a solution.

14. The computer readable program storage device of claim 13, wherein an expected return of the optimal multi-stage policy is
$$ρ ( π ) = {\sum }_{t = 1}^{T} {\sum }_{{{s}_{t} ∈ {S}_{t}}_{{a}_{t} ∈ 𝒜 ( {s}_{t} )}} r ( {s}_{t} , {a}_{t} ) \cdot {u}_{π} ( {s}_{t} , {a}_{t} )$$
wherein r(sₜ, aₜ) is the reward function for action aₜ being executed in state sₜ, u_{π}(sₜ, aₜ) is a probability of visiting sₜ and executing aₜ, T is the number of decision epochs, Sₜ is a set of states, A(sₜ) is the action set, subject to the constraints
$${\sum }_{{a}_{t} ∈ A ( {s}_{t} )} {u}_{π} ( {s}_{t} , {a}_{t} ) = {d}_{π} ( {s}_{t} ) , \\ {\sum }_{{s}_{t} , {a}_{t}} {u}_{π} ( {s}_{t} , {a}_{t} ) \cdot {a}_{t} ( {s}_{t + 1} ) = {d}_{π} ( {s}_{t + 1} ) , \\ {d}_{π} ( {s}_{1} ) = α ( {s}_{1} ) , \\ \frac{{u}_{π} ( {s}_{t} , {a}_{t} )}{{d}_{π} ( {s}_{t} )} = π ( {s}_{t} , {a}_{t} )$$
$${\sum }_{s ∈ {Q}_{i}} {d}_{π} ( s ) \leq {q}_{i} ,$$
wherein α(s_{I}) is a state probability distribution in an initial decision epoch, π(sₜ,aₜ) is a probability of applying action aₜ to state sₜ at decision epoch t, d_{π}(sₜ) is a visitation probability for state sₜ for policy π, Qᵢ is a set of visited states, and qᵢ is a visitation probability.

15. The computer readable program storage device of claim 10, wherein when the action set is continuous, the cost function is affine over a range of admissible modulations, and the set of actions is a polytope over the actions, the method includes:
replacing the continuous action set with a finite action set of extreme actions from the plurality of compact sets;
using a constrained Markov decision process (MDP) solver to find a randomized policy in the finite action set of extreme actions; and
converting the randomized policy into a deterministic policy that uses the admissible actions of state transition probabilities,
wherein said deterministic policy is the optimal multi-stage policy.

16. The computer readable program storage device of claim 15, wherein, if the constrained MDP solver returns a solution in unacceptable time, the method includes reformulating the constrained MDP as a convex optimization task, and solving the convex optimization task using a linear programming solver.

17. The computer readable program storage device of claim 16, wherein the convex optimization task is expressed as
max_{u≧0,d≧0}Σ_{sεS} r̅(s,u(s,))
s.t. d(s₁)=α(s₁)∀s₁εS₁,
d(sₜ)=Σₛ_{ₜ₊₁}u(sₜ,sₜ₊₁),
d(sₜ)=Σₛ_{_{t−1}}u(sₜ₋₁,sₜ),
Σ_{sεQ}_{ᵢ}d(s)≦qᵢ iεI,
ƒ̅ₛ^{j}(u(s,))≦0 jεJ,
wherein α(s_{I}) is a state probability distribution in an initial decision epoch, S is a set of states, d(sₜ) is a visitation probability for state sₜ,
$$\overline{r} ( s , a ) = {1}^{T} a \cdot r ( s , \frac{a}{{1}^{T} a} ) .$$
is a convex reward function wherein r(s, a) is the reward function for action a being executed in state s, u(s,) is a vector of values of u(sₜ, sₜ₊₁) which is a joint probability of visiting sₜ and transitioning to sₜ₊₁, Qᵢ is a set of visited states, and qᵢ is a visitation probability,
$${\overline{f}}_{s}^{j} ( a ) = {1}^{T} a \cdot {f}_{s}^{j} ( \frac{a}{{1}^{T} a} )$$
is a convex extension of constraint set
$${f}_{s}^{j} ( \frac{u ( s , )}{d ( s )} ) \leq 0$$
which constrains action set A(sₜ) to be a convex set, and wherein optimal solutions u*, d* define a deterministic policy π(s)=u*(s,)/d*(s) that maps a state to a vector of state transition probabilities.

18. The computer readable program storage device of claim 10, wherein the assets are loans, and the asset health levels are delinquency levels.
